(19) United States
(12) Patent Application Publication
(10) Pub. No.: US 2025/0054206 A1
(43) Pub. Date: Feb. 13, 2025

(54) BANDING ARTIFACT REDUCTION FOR DEEP LEARNING-BASED MEDICAL IMAGE RECONSTRUCTION

(71) Applicant: Siemens Healthineers AG, Forchheim (DE)

(72) Inventors: Mahmoud Mostapha, Princeton, NJ (US); Mario Zeller, Erlangen (DE); Marcel Dominik Nickel, Herzogenaurach (DE); Patrick Liebig, Erlangen (DE); Mariappan S. Nadar, Plainsboro, NJ (US)

(21) Appl. No.: 18/366,105

(22) Filed: Aug. 7, 2023

(51) Int. Cl. G06T 11/00

(52) U.S. Cl. CPC G06T 11/005; G06T 11/008; G06T 2211/424; G06T 2211/441

(57) ABSTRACT

In reconstruction, such as reconstruction in MR imaging, sub-sampled measurements from the scan are used in each iteration. By masking parts of the sub-sampled measurements (i.e., sub-sampling the acquired sub-sampled data) used in one or more iterations of reconstruction, banding is reduced or eliminated.

### FIELD

This disclosure relates to medical image reconstruction, such as reconstruction in magnetic resonance (MR) imaging.

### BACKGROUND

Medical imaging, such as magnetic resonance (MR), computed tomography (CT), positron emission tomography (PET), or single photon emission computed tomography (SPECT), use reconstruction to estimate an image or real-space object from measurements. These scans may be time consuming. For example, MR imaging (MRI) is intrinsically slow, and numerous methods have been proposed to accelerate the MRI scan. One acceleration method is the under-sampling reconstruction technique (i.e., MR compressed sensing (CS)), where fewer samples are acquired in the MRI data space (k-space), and prior knowledge is used to restore the images in reconstruction. Parallel Imaging (PI) combined with CS techniques provides faster MR Imaging (MRI) scan times.

Current deep learning MRI reconstruction is formulated as a trainable unrolled optimization framework with several cascades of regularization networks and varying data consistency layers. However, MR images reconstructed from sub-sampled Cartesian data with integrated reference lines using deep learning techniques produce images with some unnatural structures referred to as banding artifacts. Banding is characterized by a streaking pattern precisely aligned with the phase-encoding direction. This banding is anisotropic and non-homogenous across the image and most visible in high-noise or low-contrast areas. Banding results from the signal subsampling process used during Cartesian accelerated MRI, whereby subsampling occurs in one spatial direction only with a fully sampled k-space center.

In one approach to deal with banding, an adversarial loss penalizes banding structures in training the regularization networks. However, this approach provides limited reduction of the appearance of banding without complete removal. Moreover, when combined with additional adversarial losses that target improving the image sharpness, the overall training becomes challenging with increased potential of introducing hallucinations.

### SUMMARY

By way of introduction, the preferred embodiments described below include methods, systems, instructions, and computer readable media for reconstruction in medical imaging, such as reconstruction in MR imaging. In reconstruction, the measurements from the scan are used in each iteration. By masking parts of the sub-sampled measurements (i.e., sub-sampling the acquired sub-sampled data) used in one or more iterations of reconstruction, banding is reduced or eliminated.

In a first aspect, a method is provided for reconstruction of a medical image in a medical imaging system. The medical imaging system scans a patient, resulting in measurements. An image processor reconstructs the medical image from the measurements. The reconstruction includes iterations. A mask of the measurements in applied in at least one of the iterations. The medical image is displayed.

In a second aspect, a method is provided for reconstruction in magnetic resonance imaging. A magnetic resonance imaging system scans a patient using parallel imaging with compressed sensing, resulting in k-space measurements having fully sampled center lines and sub-sampling of other lines. An image processor reconstructs a magnetic resonance image from the measurements. The reconstruction uses an unrolled iterative sequence of machine-learned networks. Each of the iterations of the sequence having an input for the k-space measurement. Different masks sub-sampling the fully sampled center lines of the k-space measurements are applied to the inputs for the iterations. The magnetic resonance image is displayed.

In a third aspect, a system is provided for reconstruction in medical imaging. A magnetic resonance scanner is configured to scan a region of a patient, the scan providing sparsely sampled k-space data. An image processor is configured to reconstruct a representation of the region from the sparsely sampled k-space data. The image processor is configured to reconstruct by a sequence of cascades in an unrolled iterative reconstruction. The image processor is configured to sub-sample the sparsely sampled k-space data from the scan differently for different cascades. A display is configured to display a magnetic resonance image of the region from the reconstructed representation.

Various other embodiments, enhancements, improvements, combinations, aspects, advantages, or approaches are summarized at the end of the detailed description in the illustrative embodiments.

The present invention is defined by the following claims, and nothing in this section should be taken as a limitation on those claims. Further aspects and advantages of the invention are discussed below in conjunction with the preferred embodiments and may be later claimed independently or in combination.

### BRIEF DESCRIPTION OF THE DRAWINGS

FIG. 1 is a block diagram of an embodiment of an MR system for medical imaging by iterative reconstruction, such as unrolled iterative reconstruction with measurement masking;

FIG. 2 is a flow chart diagram of one embodiment of a method for iterative reconstruction with measurement masking to reduce banding artifact;

FIG. 3 illustrates sub-sampling by CS in a Cartesian scan;

FIG. 4 illustrates examples of banding in an MR image;

FIGS. 5 and 6 show example point spread functions given center line masking (FIG. 6) and no masking (FIG. 5);

FIG. 7 illustrates an example set of masks with an acceleration factor of 4; and

FIG. 8 illustrates an unrolled iterative reconstruction with masking applied for each iteration or cascade.

### DETAILED DESCRIPTION

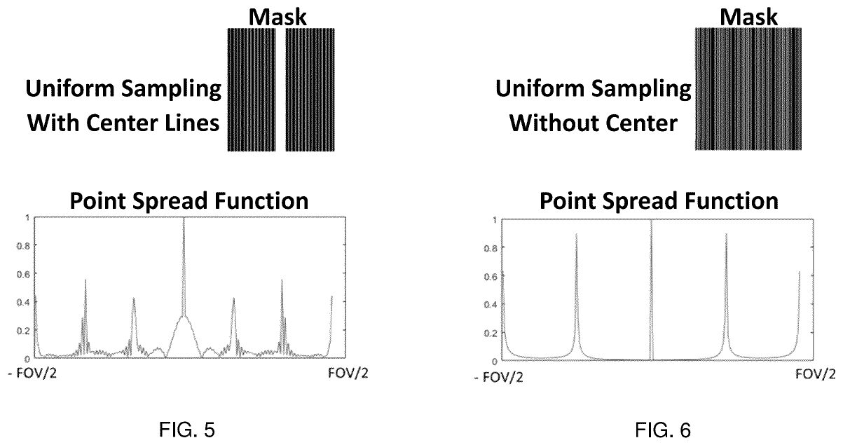

Banding artifacts may be related to the point spread function of the uniform sampling pattern with fully sampled center lines. FIGS. 5 and 6 show two examples. In FIG. 5, the fully sampled center lines are not masked, leaving all the undersampled lines of the scan. The result is a point spread function with more noise spread over the field of view. In FIG. 6, the fully sampled center lines are masked with a sub-sampling pattern matched with the uniform undersampling of the other lines. The result is a point spread function with more uniformity (less high frequency noise). The noisier point spread function of FIG. 5 may result in banding artifacts.

One naive solution would be not to acquire or drop the center lines. However, a fully-sampled k-space center has several advantages, including a better signal-to-noise ratio (SNR) and fewer aliasing artifacts at higher accelerations. Instead, the center fully-sampled k-space is uniformly sub-sampled. Different uniform sub-sampling of the center lines may be used, such as a set of masks with all possible offsets depending on the acceleration factor for the scanning. A sub-mask is selected for data consistency layers of different cascades or iterations in reconstruction to ensure a cover of the acquired k-space center while not adding additional computational overhead. With unrolled iterative reconstruction frameworks that end with less computationally expensive cascades (e.g., without a regularization network), all possible sub-masks can be utilized with results averaged for an SNR boost with slight computational overhead.

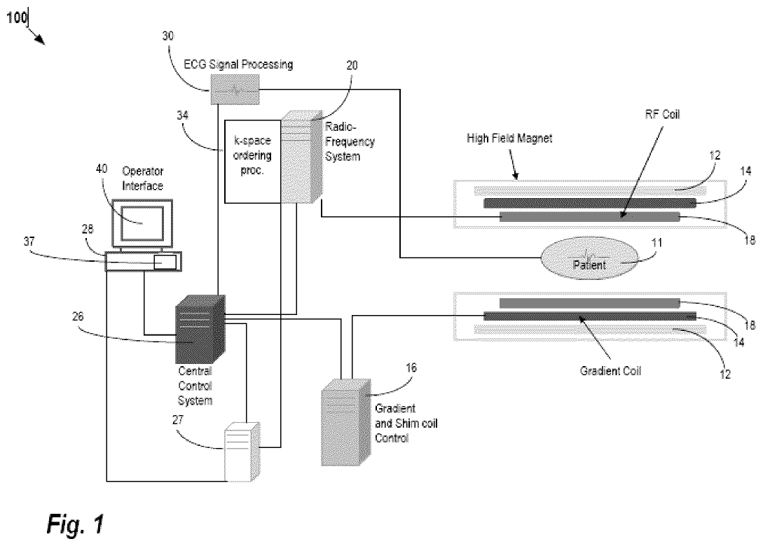

FIG. 1 shows one embodiment of a system for reconstruction in medical imaging. This example is in a magnetic resonance context (i.e., a magnetic resonance scanner), but the masking in iterative reconstruction may be used in reconstruction for CT, PET, SPECT, or other medical imaging. The masking of measurements in one or more iterations of data consistency are used for reconstruction into an object or image domain. In the discussion below, the MR context is used.

The system may use a machine-learned model in reconstruction. The machine-learned model is formed from one or more networks and/or other machine-learned architecture. For example, the machine-learned model is a deep learned neural network used for multiple iterations of the reconstruction. The machine-learned model is used in any aspect of reconstruction. In one embodiment, the machine-learned model is formed as a convolutional neural network for use as a regularizer or denoiser in the reconstruction. Image or object domain data is input, and image or object domain data with less artifact is output. The machine-learned model assists in compressed, parallel sensing, and/or other MR imaging for more rapid scanning of the patient with less artifacts. The reconstruction may also includes extrapolation. The remaining portions or stages of the reconstruction (e.g., Fourier transform and gradients in iterative optimization) are performed using reconstruction algorithms and/or other machine-learned networks included in the machine-learned model. In other embodiments, the machine-learned model replaces, at least in part, the Fourier transform so that k-space measurements are input, and image or object domain data is output. One or more parts of the reconstruction (e.g., gradient update/data consistency) uses k-space measurements. The k-space measurements are masked to reduce or eliminate banding artifacts.

The system is implemented by an MR scanner or system, a computer based on data obtained by MR scanning, a server, or another processor. MR scanning system 100 is only exemplary, and a variety of MR scanning systems can be used to collect the MR data. In the embodiment of FIG. 1, the system is or includes the MR scanner or MR system 100. The MR scanner 100 is configured to scan a patient. The scan provides scan data in a scan domain. The system 100 scans a patient to provide k-space measurements (measurements in the frequency domain). In the system 100, magnetic coils 12 create a static base magnetic field in the body of patient 11 to be positioned on a table and imaged. Within the magnet system are gradient coils 14 for producing position dependent magnetic field gradients superimposed on the static magnetic field. Gradient coils 14, in response to gradient signals supplied thereto by a gradient and shim coil control module 16, produce position dependent and shimmed magnetic field gradients in three orthogonal directions and generate magnetic field pulse sequences. The shimmed gradients compensate for inhomogeneity and variability in an MR imaging device magnetic field resulting from patient anatomical variation and other sources. The magnetic field gradients include a slice-selection gradient magnetic field, a phase-encoding gradient magnetic field, and a readout gradient magnetic field that are applied to patient 11.

RF (radio frequency) module 20 provides RF pulse signals to RF coil(s) 18, which in response produces magnetic field pulses that rotate the spins of the protons in the imaged body of the patient 11 by ninety degrees, by one hundred and eighty degrees for so-called “spin echo” imaging, or by angles less than or equal to 90 degrees for so-called “gradient echo” imaging. Gradient and shim coil control module 16 in conjunction with RF module 20, as directed by central control unit 26, control slice-selection, phase-encoding, readout gradient magnetic fields, radio frequency transmission, and magnetic resonance signal detection, to acquire magnetic resonance signals representing planar slices of patient 11.

In response to applied RF pulse signals, the RF coil(s) 18 receives MR signals, i.e., signals from the excited protons within the body as they return to an equilibrium position established by the static and gradient magnetic fields. The MR signals are detected and processed by a detector within RF module 20 and k-space component processor unit 34 to provide an MR dataset to an image processor for processing into an image (i.e., for reconstruction in the object domain from the k-space data in the scan domain). In some embodiments, the image processor is located in or is the central control unit 26. In other embodiments, such as the one depicted in FIG. 1, the image processor is located in a separate unit 27. ECG synchronization signal generator 30 provides ECG signals used for pulse sequence and imaging synchronization. A two- or three-dimensional k-space storage array of individual data elements in k-space component processor unit 34 stores corresponding individual frequency components forming an MR dataset. The k-space array of individual data elements has a designated center, and individual data elements individually have a radius to the designated center.

A magnetic field generator (comprising coils 12, 14 and 18) generates a magnetic field for use in acquiring multiple individual frequency components corresponding to individual data elements in the storage array. The individual frequency components are successively acquired using a Cartesian acquisition strategy as the multiple individual frequency components are sequentially acquired during acquisition of an MR dataset representing an MR image. A storage processor in the k-space component processor unit 34 stores individual frequency components acquired using the magnetic field in corresponding individual data elements in the array. The row and/or column of corresponding individual data elements alternately increases and decreases as multiple sequential individual frequency components are acquired. The magnetic field acquires individual frequency components in an order corresponding to a sequence of substantially adjacent individual data elements in the array, and magnetic field gradient change between successively acquired frequency components is substantially minimized. The central control processor 26 is programmed to sample the MR signals according to a predetermined sampling pattern. Any MR scan sequence may be used, such as for T1, T2, or other MR parameter.

In one embodiment, a compressive sensing scan sequence is used, such as a parallel imaging combined with compressive sensing. The scan provides sparsely sampled k-space data. Any under sampling or sub-sampling pattern may be used. In one embodiment, the center lines (e.g., autocalibration region) of the Cartesian format scan are fully sampled. Any number of center lines may be fully sampled, depending on the acceleration factor of the scan. The other lines are sub-sampled or under sampled, such as sampling every 4^{th} line.

The central control unit 26 also uses information stored in an internal database to process the detected MR signals in a coordinated manner to generate high quality images of a selected slice(s) of the body (e.g., using the image data processor) and adjusts other parameters of system 100. The stored information comprises predetermined pulse sequence and magnetic field gradient and strength data as well as data indicating timing, orientation, and spatial volume of gradient magnetic fields to be applied in imaging.

The central control unit 26 (i.e., controller) and/or processor 27 are an image processor that reconstructs a representation of the patient from the k-space data. The image processor is a general processor, digital signal processor, three-dimensional data processor, graphics processing unit, application specific integrated circuit, field programmable gate array, artificial intelligence processor, digital circuit, analog circuit, combinations thereof, and/or another now known or later developed device for reconstruction. The image processor is a single device, a plurality of devices, or a network. For more than one device, parallel or sequential division of processing may be used. Different devices making up the image processor may perform different functions, such as reconstructing by one device and volume rendering by another device. In one embodiment, the image processor is a control processor or other processor of the MR scanner 100. Other image processors of the MR scanner 100 or external to the MR scanner 100 may be used.

The image processor is configured by software, firmware, and/or hardware to reconstruct. The image processor operates pursuant to stored instructions to perform various acts described herein.

The image processor is configured to reconstruct a representation in an object domain. The object domain is an image space and corresponds to the spatial distribution of the patient. A planar area or volume representation is reconstructed as an image representing the patient. For example, pixels values representing tissue in an area or voxel values representing tissue distributed in a volume are generated.

The representation in the object domain is reconstructed from the scan data in the scan domain. The scan data is a set or frame of k-space data from a scan of the patient. The k-space measurements resulting from the scan sequence are transformed from the frequency domain to the spatial domain in reconstruction. In general, reconstruction is an iterative process, such as a minimization problem. This minimization can be expressed as:

$$x = \begin{matrix}arg min \\ x\end{matrix} {‖ Ax - y ‖}_{2}^{2} + λ {‖ Tx ‖}_{1} \qquad ( 1 )$$

where x is the target image to be reconstructed, and y is the raw k-space data. A is the MRI model to connect the image to MRI-space (k-space), which can involve a combination of an under-sampling matrix U, a Fourier transform F, and sensitivity maps S. T represents a sparsifying (shrinkage) transform. A is a regularization parameter. The first term of the right side of equation 1 represents the image (2D or 3D spatial distribution or representation) fit to the acquired data, and the second term of the right side is a term added for denoising by reduction of artifacts (e.g., aliasing) due to under sampling. The l1 norm is used to enforce sparsity in the transform domain. ∥Ax−y∥₂² is the l2 norm of the variation of the under-sampled k-space data. Generally, the lp norm is

$$\sqrt[p]{\sum {\vert x \vert}^{p}} .$$

In some embodiments, the operator T is a wavelet transform. In other embodiments, the operator T is a finite difference operator in the case of Total Variation regularization.

The image processor may be configured to optimize as part of reconstruction, such as performing a sequence of iterations. A same machine-learned network may be used in each iteration. Alternatively, a machine-learned network is not used. In another approach, the image processor is configured to reconstruction by a sequence of cascades or iterations in an unrolled iterative reconstruction. Each iteration uses a separate model, such as separate machine-learned networks. In any of these approaches, each iteration uses the k-space measurements, such as in a data-consistency operation.

The image processor is configured to sub-sample the sparsely sampled k-space data from the scan differently for different cascades or iterations. A mask is applied to the k-space measurements, such as masking out one or more center lines. In one approach, the image processor is configured to generate different sub-sample patterns (masks) for the sub-sampling. The sub-sample patterns are based on an acceleration factor of the scan, such as generating four masks M1-4 where the acceleration factor (e.g., PAT4) provides for uniformly sub-sampling every fourth line. Each mask is formed by using a different offset 0-3 corresponding to the acceleration factor. Each offset shifts the sub-sampling by a line. For reconstruction, the image processor is configured to select (e.g., randomly) one of the different sub-sample patterns for each of the cascades or iterations. A preset pattern may instead be used matching different masks to different cascades or iterations. Each of the cascades includes a machine-learned network or function (operation) that has an input for the sub-sampled sparsely sampled k-space data.

In one approach, the sequence of cascades of the unrolled iterative reconstruction model includes first cascades with data consistency and regularization functions and includes at least a second cascade with the data consistency function and no regularization function. Different masks are selected for different ones of the first cascades. The image processor is configured to perform the second cascade multiple times with different ones of the sub-sampled (masked) sparsely sampled k-space data and average results from the performance of the second cascade.

The image processor may be configured to generate an MR image from the reconstructed representation. Where the representation is of an area, the values of the representation may be mapped to display values (e.g., scalar values to display color values) and/or formatted (e.g., interpolated to a display pixel grid). Alternatively, the output representation is of display values in the display format. Where the representation is of a volume, the image processor performs volume or surface rendering to render a two-dimensional image from the voxels of the volume. This two-dimensional image may be mapped and/or formatted for display as an MR image. Any MR image generation may be used so that the image represents the measured MR response from the patient. The image represents a region of the patient.

Generated images of the reconstructed representation for a given patient are presented on a display 40 of the operator interface. Computer 28 of the operator interface includes a graphical user interface (GUI) enabling user interaction with central control unit 26 and enables user modification of magnetic resonance imaging signals in substantially real time. Display processor 37 processes the magnetic resonance signals to provide image representative data for display on display 40, for example.

The display 40 is a CRT, LCD, plasma, projector, printer, or other display device. The display 40 is configured by loading an image to a display plane or buffer. The display 40 is configured to display the reconstructed MR image.

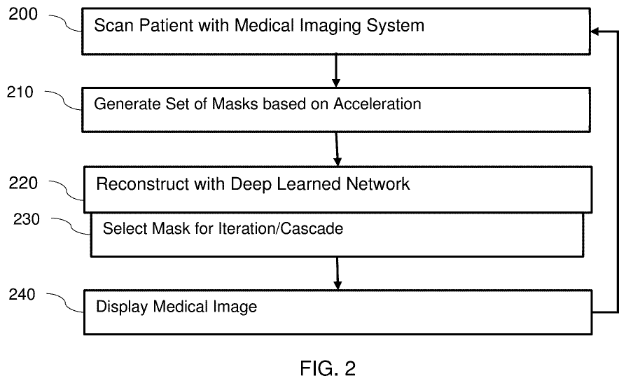

FIG. 2 is a flow chart diagram of one embodiment of a method for reconstruction of a medical image in a medical imaging system, such as reconstruction of a MR image in an MR system. To reduce or eliminate banding artifact, the measurements (e.g., k-space measurements) used in one or more iterations are masked, such as not using one or more measurements.

The method is performed by the system of FIG. 1 or another system. The medical scanner scans the patient. An image processor reconstructs the image, and a display displays the medical image. A memory may provide the masks, or the image processor generates the masks. Other components may be used, such as a remote server or a workstation performing the mask generation, reconstruction, and/or display.

The method is performed in the order shown (top to bottom or numerical) or other orders. For example, the masks may be generated prior to the scan of the patient. Additional, different, or fewer acts may be provided. For example, a preset, default, or user input settings are used to configure the scanning prior to act 200. As another example, the image is stored in a memory (e.g., computerized patient medical record) or transmitted over a computer network instead of or in addition to the display of act 240.

In act 200, the medical system scans a patient. For example, an MR scanner or another MR system scans the patient with an MR compressed (e.g., under sampling) or another MR sequence. For example, a compressed sensing in parallel imaging scan is performed. The amount of under sampling is based on the settings, such as the acceleration (acceleration factor). Based on the configuration of the MR scanner, a pulse sequence is created. The pulse sequence is transmitted from coils into the patient. The resulting responses are measured by receiving radio frequency signals at the same or different coils. The scanning results in k-space measurements as the scan data. In another example, a computed tomography scanner scans a patient by transmitting x-rays from different angles through the patient. The scanning results in detected projections for a given patent as the scan data.

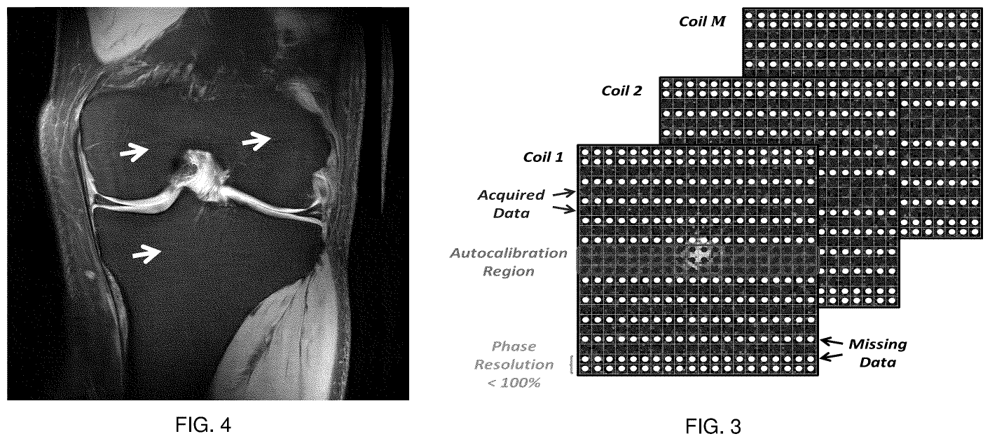

FIG. 3 illustrates example k-space measurements obtained by a scan using parallel imaging with compressed sensing. The acceleration factor is two (e.g., PAT2). K-space measurements are acquired for each of M coils. The dark or black dots represent acquired k-space measurements in a Cartesian scan format. The white dots represent missing k-space measurements (data not acquired due to under sampling). Any sampling pattern may be provided. In these examples, there are three center lines (autocalibration region) where full sampling is used. In other examples, under sampling may be used for the center lines. The other lines (non-center lines) are sub-sampled (i.e., under sampled) using any pattern. The amount of sub-sampling or under sampling is controlled by the acceleration factor. The sampling may be uniform. Variation may be provided in the sub-sampling, such as generally or uniformly sampling every Nth line but with greater or lesser sub-sampling for the center and/or edges.

FIG. 4 shows an image of a slice (plane) reconstructed from the k-space measurements of FIG. 3. Three white arrows indicate the locations of three banding artifacts (e.g., dark lines or bands in the phase encoding direction located in low-contrast regions). Masking the k-space measurements used in one or more iterations of the reconstruction may reduce or eliminate the banding artifacts.

In act 210 of FIG. 2, the image processor generates a set of the different masks with different offsets. The masks are created as needed. Alternatively, the masks are generated by loading from memory. The masks are pre-computed, such as having different sets of masks for different acceleration factors and/or scanning configurations.

The set includes any number of masks, such as one or more. In one approach, the number of the different masks is based on the acceleration factor. For example, the acceleration factor is 4, so 4 masks are generated. Other ratios, such as 2 masks for an acceleration factor of 4, may be used. Fractional acceleration factors may be rounded to the nearest even integer or handled in a different way.

In one embodiment, the acceleration factor provides the number of skipped lines in under sampling. For example, an acceleration factor of 4 provides for every fourth line being sampled (skip 3 lines). This under sampling may be for some of the lines and not others, such as not the center lines. The result is 3 center lines fully sampled. The masks select different ones or combinations of the center lines to use. For example, an offset is provided. The offset is a beginning line to pass with the next X (e.g., 3) lines to not select (i.e., mask). The offset is 0-3 so that each of the four masks sub-samples to provide a different or no center line. Different offsets are used where the offset is based on the acceleration factor. The number of offsets is provided by the acceleration factor for the scanning.

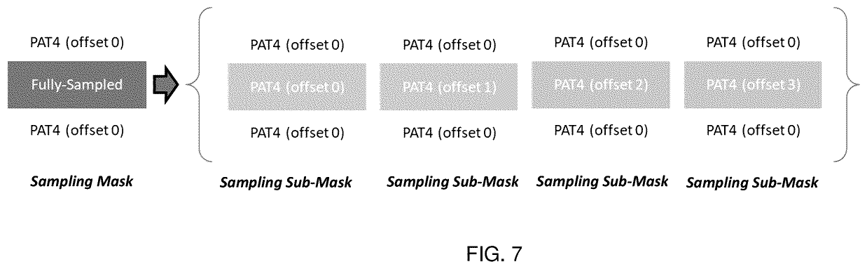

FIG. 7 illustrates an example. The acceleration factor (PAT) is 4. The masks are for just the center lines. The center lines are to be sub-sampled by the mask. With an acceleration factor of 4, the set of masks generated includes 4 masks, each with a different offset (e.g., starting line for passing through the mask). Each of the 4 masks is a sub-sampling of the center lines of the k-space measurements (sampling sub-mask). Other sampling or masking patterns may be used. In other embodiments, other combinations of offsets, number of masks, and/or combinations of lines to include as being passed by the masks may be provided based or not based on the acceleration factor.

FIG. 5 shows an example of uniform (repeating pattern) under sampling due to a CS scan. The white lines represent acquired lines in the sub-sampling provided by the scan. The center lines are fully sampled. The mask passes all data resulting from the CS under sampling, so is not a mask applied to the acquired measurement. FIG. 6 shows application of a mask to the acquired measurements. The mask is for just the center lines. The mask sub-samples the center lines to make the pattern of overall measurements being used in reconstruction more uniform. Only some of the acquired center line measurements are used. The mask sub-samples the center line sampling, resulting in a different center line sampling. Fewer of the center lines are used or applied in the cascade or iteration of reconstruction. Even where the center lines are under sampled (not fully sampled) in the CS scanning, the mask may sub-sample. In other embodiments, the mask masks other lines than the center lines.

In one embodiment, the center fully-sampled k-space is uniformly sub-sampled with all possible offsets (depending on the acceleration PAT factor). This creates corresponding sub-masks (FIG. 7). To generalize to different acceleration factors, a maximum acceleration factor is set (e.g., PAT=8) depending on the targeted use case. This maximum acceleration factor or the acceleration factor to be used determines the size of the set of sub-masks.

The masks, as generated, are fed to the network as an input. The masks and/or measurements as masked are used in reconstruction.

In act 220 of FIG. 2, the image processor reconstructs the medical image (e.g., MR image) from the measurements. The reconstruction includes iterations where at least some of the iterations include a data consistency check with projection using a model of the scanner. A mask of the measurements is applied in at least one of the iterations. The measurements as sub-sampled by the mask are applied or used in the iteration.

The image processor reconstructs a representation of the patient from the scan data. For MR reconstruction, the k-space data is Fourier transformed into scalar values representing different spatial locations, such as spatial locations representing a plane through or volume of a region in the patient. Scalar pixel or voxel values are reconstructed as the MR image. The spatial distribution of measurements in object or image space is formed. This spatial distribution represents the patient. The reconstruction forms an object or patient representation in two- or three-dimensional space from the measurements in a scan space (e.g., k-space). For example, a three-dimensional distribution of voxels representing a volume of the patient is reconstructed from the measurements.

In one approach, the reconstruction uses optimization based on functions. In another approach, one or more functions in the reconstruction are replaced by or performed by a machine-learned model, such as a neural network. In yet another approach, an unrolled iterative reconstruction is used. Each iteration is formed separately, such as having one or more parameters set differently. Where machine-learning is used, each iteration may use a different machine-learned network. In any of these approaches, the measurements used in one or more iterations are masked.

In one embodiment, the machine-learned network of the machine-learned model implements a regularizer. The reconstruction is performed iteratively with gradients (gradient update or data consistency check), a Fourier transform, and the regularizer. The regularizer receives image space information from the Fourier transform or after the gradient operation and outputs denoised image space information. The machine-learned network may be an image-to-image network with DenseNet blocks or have another architecture, such as a CNN.

In another embodiment, the machine-learned model includes an extrapolation function or algorithm with a machine-learned parameter. For example, the value for the weight applied in a Nesterov or Polyak heavy ball extrapolation was machine learned. The extrapolation operates on an input image data and outputs to the gradient update. The learned value of the parameter is used in the extrapolation. For example, the machine-learned parameter is a weight for a difference between current and previous image values. The extrapolation provides momentum to the gradient descent.

The reconstruction is iterative. Each iteration or cascade determines an updated image object from an input image object, with the gradient operation comparing fit with the measurements. For example, an unrolled iterative reconstruction is performed. Different machine-learned networks and/or extrapolation weights are used for the different iterations. Some iterations may not include regularization. For example, an initial sequence of iterations includes extrapolation with learned weights and does not include regularization, and a subsequent sequence of iterations includes regularization with or without extrapolation with learned weights. After the last iteration, the output representation by the regularizer or gradient update is provided for imaging or the medical record of the patient.

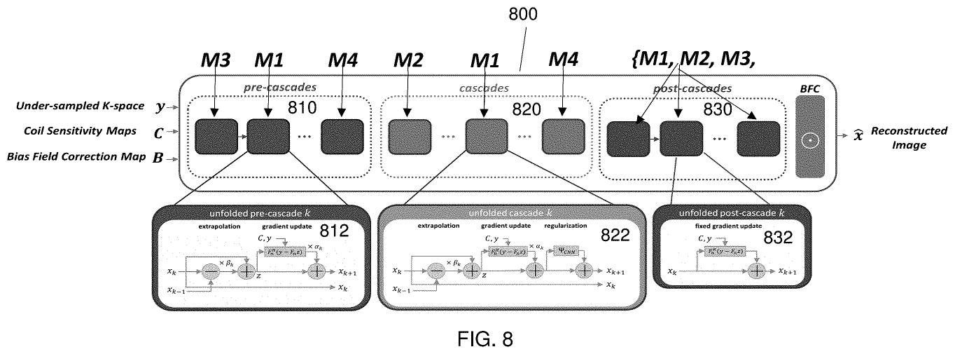

FIG. 8 shows an example of unrolled iterative reconstruction as a network or model 800 of iteration sequences 810, 820, 830. The unrolled iterative reconstruction includes three sequences 810, 820, 830 of iterations 812, 822, 832, respectively. Each dark box represents a cascade or iteration in the reconstruction. The earlier sequence 810 (labeled “pre-iterations”) includes iterations 812 with extrapolation and gradient updates. Regularization is not included in the iterations 812. The middle sequence 820 includes iterations 822 with extrapolation, gradient update, and regularization. The last sequence 830 includes iterations 832 with gradient updates without regularization. In other embodiments, other sequences with other combinations of operations may be provided. Other orders of the different sequences 810, 820, 830 may be provided. By including different sequences, the number of operations or computational cost for some iterations may be reduced. Alternatively, all the iterations have the same operations.

The network 800 also includes bias field correction (BCF). The input bias field correction map, B, is applied to correct for biases in the image object output after the iterations. Other filtering and/or operations for reconstruction and/or post-reconstruction may be provided.

The iterations 822 with regularization includes the regularizer operating on the output of the gradient update. The regularizer is a machine-learned network. In one embodiment, deep learning is used to train a convolutional neural network as the regularizer. Machine learning is an offline training phase where the goal is to identify an optimal set of values of learnable parameters of the model that can be applied to many different inputs (i.e., image domain data after gradient calculation in the optimization or minimization of the reconstruction). These machine-learned parameters can subsequently be used during clinical operation to rapidly reconstruct images. Once learned, the machine-learned model is used in an online processing phase in which MR scan data y (e.g., k-space measurements) for patients is input and the reconstructed representations for the patients are output based on the model values learned during the training phase. Other functions (e.g., extrapolation and/or gradient update) may use machine-learned models or networks. Coil sensitivity maps C for the one or more coils and/or other information representing the model of the scanner may be input for use in each, one, or more iterations.

During application to one or more different patients and corresponding different measurements, the same learned weights or values for machine-learned network for each iteration are used. The model and values for the learnable parameters are not changed from one patient to the next, at least over a given time (e.g., weeks, months, or years) or given number of uses (e.g., tens or hundreds). These fixed values and corresponding fixed model are applied sequentially and/or by different processors to scan data for different patients. The model may be updated, such as retrained, or replaced but does not learn new values as part of application for a given patient.

The model has an architecture. This structure defines the learnable variables and the relationships between the variables. In one embodiment for the regularization, a neural network is used, but other networks may be used. For example, a convolutional neural network (CNN) is used. Any number of layers and nodes within layers may be used. A DenseNet, U-Net, encoder-decoder, Deep Iterative Down-Up CNN, and/or another network may be used. In one embodiment, an image-to-image neural network (spatial distribution input and spatial distribution output) is used. The image-to-image neural network may include convolution layers or be a CNN. Some of the network may include dense blocks (i.e., multiple layers in sequence outputting to the next layer as well as the final layer in the dense block). Any know known or later developed neural network may be used.

Deep learning is used to train the model for each iteration where machine learning is used. The training learns both the features of the input data and the conversion of those features to the desired output (i.e., denoised or regularized image domain data). Backpropagation, RMSprop, ADAM, or another optimization is used in learning the values of the learnable parameters. Where the training is supervised, the differences (e.g., L1, L2, or mean square error) between the estimated output and the ground truth output are minimized. Where a discriminator is used in training, the ground truth is not needed. Instead, the discriminator determines whether the output is real or estimated as an objective function for feedback in the optimization. The characteristic is one that likely distinguishes between good and bad output by examining the output rather than by comparison to a known output for that sample. Joint training (e.g., semi-supervised) may be used.

The training uses multiple samples of input sets, such as object domain data representing patients after Fourier transform and/or gradient calculation. The measurements for these samples are generated by scanning a patient and/or phantom with different settings or sequences, scanning different patients and/or phantoms with the same or different settings or sequences, and/or simulating MR scanning with an MR scanner model. By using many samples, the model is trained given a range of possible inputs. The samples are used in deep learning to determine the values of the learnable variables (e.g., values for convolution kernels) that produce outputs with minimized cost function and/or maximized likelihood of being a good representation (i.e., discriminator cannot tell the difference) across the variance of the different samples. Masking of the measurements may or may not be used for training.

In one embodiment, the image processor is configured to reconstruct with the CNN as trained being used as a regularizer in the reconstruction. The iterative reconstruction may be unrolled where a given number of iterations is used. The same CNN is used for each iteration. Alternatively, a different CNN is provided for each iteration, whether a different architecture or same architecture but with different values for one or more of the learnable parameters of the CNN. Different CNNs are trained for different iterations in the reconstruction. Each CNN may have the same architecture, but each is separately learned so that different values of the learnable parameters may be provided for different iterations of the reconstruction.

Once trained, the machine-learned model is used for reconstruction of a spatial representation from input k-space measurements for a patient. Some of or all the iterations use k-space measurements as an input. The k-space measurements may be input to a machine-learned model or to a function/operation of the reconstruction (e.g., gradient update). The measurements, y, used or input are masked to reduce banding artifacts. For example, rather than using all the center lines acquired in the compressed sensing scan, only center lines passing through or filtered by a mask are used.

In application of the already trained network, the reconstruction process is followed. The machine-learned model is used in the reconstruction. For example, extrapolation is performed in every or some iterations using weights learned for those iterations, and regularization is performed in every or only some iterations using the deep learned network (e.g., CNN). In response to the input for a given patient, a patient specific image is reconstructed. The machine-learned model outputs the image as pixels, voxels, and/or a display formatted image in response to the input. The learned values and network architecture, with any algorithms (e.g., extrapolation and gradient update) determine the output from the input.

Different or the same masks may be used for different iterations. The different masks may be applied to the k-space measurements of the center lines for input to respective different iterations. The masked measurements may be input to a machine-learned network, such as a machine-learned network to implement the gradient update. Alternatively, the masked measurements are input to the gradient update (data consistency) function or operation without being input to a machine-learned network. Each or at least some of the iterations in the unrolled iterative sequence use measurements as masked.

In the example of FIG. 8, at least one of the masks is applied for the measurements input to each iteration. In this example, there are four masks M1-4 (see FIG. 7). A given mask M is used for one or more iterations. Other masks are used for one or more iterations. In alternative embodiments, one or more masks are not used, and/or some iterations use measurements without masking.

In act 230, the image processor selects masks to be used for one or more iterations (cascades). The mask to use for any iteration may be set. A pattern may be applied to mask selection for each sequence 810, 820, 830. In one approach, the masks applied for the iterations of one or more sequences (e.g., 810 and 820) is random. One of the different masks is randomly selected for each iteration in the unrolled iterative sequence. For example, the sub-mask M3 is randomly selected for data consistency layers of different cascades (iterations) to ensure a cover of the acquired k-space center while not adding additional computational overhead. A sub-mask will be randomly selected from such fixed length set, allowing for a unified framework handling different acceleration factors. In the example of FIG. 8, for the shown iterations, masks M1 and M4 are used twice and masks M3 and M2 are used once in the iterations with regularization. The measurements used in gradient update (data consistency) are masked, at least in part (e.g., center lines).

For iterations without regularization, another approach may be used. For a given iteration, the operation may be performed multiple times with different masks. In the example of FIG. 8, the iterations 832 without regularization each use all the masks M1-M4). Fewer than all may be used, such as 1, 2, or 3 masks in the 4-mask example. The results derived from the iteration in response to inputs of the k-space measurements from each of the multiple masks are averaged. With unrolled iterative reconstruction frameworks that end with less computationally expensive cascades (iterations without a regularization network), all or a sub-set of possible sub-masks are utilized with results averaged for an SNR boost with slight computational overhead. Other combinations than averaging may be used. In yet another approach, only one mask is applied for the iteration (cascade) 832 of the iterations without regularization.

In the example of FIG. 8, a first part of the unrolled iterative sequence includes regularization (iterations 810 and 820) where each of the iterations of the first part have inputs of the k-space measurements masked by ones of the different masks. A second part of the unrolled iterative sequence does not include regularization (iterations 830) where multiple of the masks are applied for each one, multiple, or all the iterations of the second part.

The image processor reconstructs a magnetic resonance image from the measurements. The reconstruction uses an unrolled iterative sequence of cascades, which may include machine-learned networks. Each or some of the cascades have an input for the k-space measurements. Different masks sub-sampling the fully sampled center lines of the k-space measurements are applied to the inputs for the cascades.

The output of the machine-learned network is a two-dimensional distribution of pixels representing an area of the patient and/or a three-dimensional distribution of voxels representing a volume of the patient. The output from the last iteration may be used as the output representation of the patient.

Other processing may be performed on the output representation or reconstruction, such as spatial filtering, color mapping, and/or display formatting. In one embodiment, the reconstruction outputs voxels or scalar values for a volume spatial distribution as the medical image. Volume rendering is performed to generate a display image as a further display image. In alternative embodiments, the machine-learned network outputs the display image directly in response to the input

In act 240 of FIG. 2, a display (e.g., display screen) displays the medical image, such as the MR image. The medical image is formatted for display on the display. The display presents the image for viewing by the user, radiologist, physician, clinician, and/or patient. The image assists in diagnosis.

The displayed image may represent a planar region or area in the patient. Alternatively, or additionally, the displayed image is a volume or surface rendering from voxels (three-dimensional distribution) to the two-dimensional display.

Banding artifacts are reduced or entirely removed (not present) in the medical image. The banding artifacts are not present by directly adapting the input measurements to different network layers without requiring customized adversarial loss functions. The proposed generic solution can be utilized in various k-space-to-image networks, including 2D, 2D+t, 3D, 3D, and 3D+t applications with Cartesian sampling.

Below are illustrative embodiments:

Illustrative embodiment 1. A method for reconstruction of a medical image in an medical imaging system, the method comprising: scanning, by the medical imaging system, a patient, the scanning resulting in measurements; reconstructing, by an image processor, the medical image from the measurements, the reconstructing including iterations, wherein a mask of the measurements in applied in at least one of the iterations; and displaying the medical image.

Illustrative embodiment 2. The method of illustrative embodiment 1 wherein scanning comprises scanning with the medical imaging system being a magnetic resonance (MR) scanner using compressed sensing and the measurements being k-space measurements.

Illustrative embodiment 3. The method of illustrative embodiment 2 wherein the measurements include a first center line sampling, and wherein the mask sub-samples the first center line sampling, resulting in a second center line sampling, the measurements from the second center line sampling used in the one of the iterations.

Illustrative embodiment 4. The method of illustrative embodiment 3 wherein the first center line sampling comprises a full sampling of center lines.

Illustrative embodiment 5. The method of any of illustrative embodiments 1-4 wherein reconstructing comprises reconstructing a three-dimensional distribution of voxels representing a volume of the patient, and wherein displaying comprises volume or surface rendering from the voxels to a two-dimensional display.

Illustrative embodiment 6. The method of any of illustrative embodiments 1-5 wherein reconstructing comprises reconstructing as an unrolled iterative reconstruction, each iteration using a different machine-learned network.

Illustrative embodiment 7. The method of illustrative embodiment 6 wherein reconstructing comprises reconstructing with the different machine-learned networks, the mask being for one of the iterations and corresponding inputs to that one iteration, other masks being used for other of the iterations.

Illustrative embodiment 8. The method of illustrative embodiments 7 further comprising generating the masks based on different offsets, the different offsets based on an acceleration factor for the scanning, the mask for the one iteration selected randomly from the masks.

Illustrative embodiment 9. The method of any of illustrative embodiments 7-8 wherein the other masks are used for other of the iterations.

Illustrative embodiment 10. The method of any of illustrative embodiments 7-9 wherein all of the masks are used for each iteration where the corresponding iteration is free of regularization.

Illustrative embodiment 11. A method for reconstruction in magnetic resonance imaging, the method comprising: scanning, by a magnetic resonance imaging system using parallel imaging with compressed sensing, a patient, the scanning resulting in k-space measurements having fully sampled center lines and sub-sampling of other lines; reconstructing, by an image processor, a magnetic resonance image from the measurements, the reconstructing using an unrolled iterative sequence of machine-learned networks, each of the iterations of the sequence having an input for the k-space measurement, wherein different masks sub-sampling the fully sampled center lines of the k-space measurements are applied to the inputs for the iterations; and displaying the magnetic resonance image.

Illustrative embodiment 12. The method of illustrative embodiment 11 wherein scanning comprises scanning with an acceleration factor; and further comprising: generating a set of the different masks with different offsets, a number of the different masks based on the acceleration factor; and randomly selecting one of the different masks for each of at least some of the iterations of the unrolled iterative sequence.

Illustrative embodiment 13. The method of any of illustrative embodiments 11-12 wherein a first part the unrolled iterative sequence includes gradient update where each of the gradient updates of the first part have inputs of the k-space measurements masked by ones of the different masks and a second part of the unrolled iterative sequence does not include regularization where multiple of the masks are applied for one of the gradient updates of the second part.

Illustrative embodiment 14. The method of illustrative embodiment 13 wherein results derived from the one gradient update in response to inputs of the k-space measurements from each of the multiple masks are averaged.

Illustrative embodiment 15. The method of any of illustrative embodiments 11-14 wherein reconstructing comprises applying the different masks to the k-space measurements of the center lines for input to the respective iteration.

Illustrative embodiment 16. A system for reconstruction in medical imaging, the system comprising: a magnetic resonance scanner configured to scan a region of a patient, the scan providing sparsely sampled k-space data; an image processor configured to reconstruct a representation of the region from the sparsely sampled k-space data, the image processor configured to reconstruct by a sequence of cascades in an unrolled iterative reconstruction, wherein the image processor is configured to sub-sample the sparsely sampled k-space data from the scan differently for different cascades; and a display configured to display a magnetic resonance image of the region from the reconstructed representation.

Illustrative embodiment 17. The system of illustrative embodiment 16 wherein the magnetic resonance scanner is configured to scan with parallel imaging combined with compressed sensing along a Cartesian format where the provided sparsely sampled k-space data includes fully sampled center lines, and wherein the sub-sampling is of the fully sampled center lines.

Illustrative embodiment 18. The system of any of illustrative embodiments 16-17 wherein the image processor is configured to generate different sub-sample patterns for the sub-sampling based on an acceleration factor of the scan and configured to randomly select one of the different sub-sample patterns for each of the cascades.

Illustrative embodiment 19. The system of any of illustrative embodiments 16-18 wherein the sequence of cascades includes first cascades with data consistency and regularization functions and includes at least a second cascade with the data consistency function and no regularization function, wherein the image processor is configured to perform the second cascade multiple times with different ones of the sub-sampled sparsely sampled k-space data and average results from the performance of the second cascade.

Illustrative embodiment 20. The system of any of illustrative embodiments 16-19 wherein each of the cascades includes an input for the sub-sampled sparsely sampled k-space data.

Although the subject matter has been described in terms of exemplary embodiments, it is not limited thereto. Rather, the appended claims should be construed broadly, to include other variants and embodiments, which can be made by those skilled in the art.

What is claimed is:

1. A method for reconstruction of a medical image in a medical imaging system, the method comprising:
scanning, by the medical imaging system, a patient, the scanning resulting in measurements;
reconstructing, by an image processor, the medical image from the measurements, the reconstructing including iterations, wherein a mask of the measurements is applied in at least one of the iterations; and
displaying the medical image.

2. The method of claim 1 wherein scanning comprises scanning with the medical imaging system being a magnetic resonance (MR) scanner using compressed sensing and the measurements being k-space measurements.

3. The method of claim 2 wherein the measurements include a first center line sampling, and wherein the mask sub-samples the first center line sampling, resulting in a second center line sampling, the measurements from the second center line sampling used in the one of the iterations.

4. The method of claim 3 wherein the first center line sampling comprises a full sampling of center lines.

5. The method of claim 1 wherein reconstructing comprises reconstructing a three-dimensional distribution of voxels representing a volume of the patient, and wherein displaying comprises volume or surface rendering from the voxels to a two-dimensional display.

6. The method of claim 1 wherein reconstructing comprises reconstructing as an unrolled iterative reconstruction, each iteration using a different machine-learned network.

7. The method of claim 6 wherein reconstructing comprises reconstructing with the different machine-learned networks, the mask being for one of the iterations, other masks being used for other of the iterations.

8. The method of claim 7 further comprising generating the masks based on different offsets, the different offsets based on an acceleration factor for the scanning, the mask for the one iteration selected randomly from the masks.

9. The method of claim 7 wherein the other masks are used for other of the iterations.

10. The method of claim 7 wherein all the masks are used for each iteration where the corresponding iteration is free of regularization.

11. A method for reconstruction in magnetic resonance imaging, the method comprising:
scanning, by a magnetic resonance imaging system using parallel imaging with compressed sensing, a patient, the scanning resulting in k-space measurements having fully sampled center lines and sub-sampling of other lines;
reconstructing, by an image processor, a magnetic resonance image from the measurements, the reconstructing using an unrolled iterative sequence of machine-learned networks, each of the iterations of the sequency having an input for the k-space measurement, wherein different masks sub-sampling the fully sampled center lines of the k-space measurements are applied to the inputs; and
displaying the magnetic resonance image.

12. The method of claim 11 wherein scanning comprises scanning with an acceleration factor; and
further comprising:
generating a set of the different masks with different offsets, a number of the different masks based on the acceleration factor; and
randomly selecting one of the different masks for each of at least some of the iterations.

13. The method of claim 11 wherein a first part the unrolled iterative sequence includes gradient update where each of the gradient updates of the first part have inputs of the k-space measurements masked by ones of the different masks and a second part of the unrolled iterative sequence does not include regularization where multiple of the masks are applied for one of the gradient updates of the second part.

14. The method of claim 13 wherein results derived from the gradient update in response to inputs of the k-space measurements from each of the multiple masks are averaged.

15. The method of claim 11 wherein reconstructing comprises applying the different masks to the k-space measurements of the center lines for input to the iteration.

16. A system for reconstruction in medical imaging, the system comprising:
a magnetic resonance scanner configured to scan a region of a patient, the scan providing sparsely sampled k-space data;
an image processor configured to reconstruct a representation of the region from the sparsely sampled k-space data, the image processor configured to reconstruct by a sequence of cascades in an unrolled iterative reconstruction, wherein the image processor is configured to sub-sample the sparsely sampled k-space data from the scan differently for different cascades; and
a display configured to display a magnetic resonance image of the region from the reconstructed representation.

17. The system of claim 16 wherein the magnetic resonance scanner is configured to scan with parallel imaging combined with compressed sensing along a Cartesian format where the provided sparsely sampled k-space data includes fully sampled center lines, and wherein the sub-sampling is of the fully sampled center lines.

18. The system of claim 16 wherein the image processor is configured to generate different sub-sample patterns for the sub-sampling based on an acceleration factor of the scan and configured to randomly select one of the different sub-sample patterns for each of the cascades.

19. The system of claim 16 wherein the sequence of cascades includes first cascades with data consistency and regularization functions and includes at least a second cascade with the data consistency function and no regularization function, wherein the image processor is configured to perform the second cascade multiple times with different ones of the sub-sampled sparsely sampled k-space data and average results from the performance of the second cascade.

20. The system of claim 16 wherein each of the cascades includes an input for the sub-sampled sparsely sampled k-space data.
